(19) United States
(12) Patent Application Publication
(10) Pub. No.: US 2024/0187498 A1
(43) Pub. Date: Jun. 6, 2024

(54) STALE CACHE DATA IN CHARGING FUNCTION

(71) Applicant: T-Mobile USA, Inc., Bellevue, WA (US)

(72) Inventor: Muhammad Zaeem Afzal, McKinney, TX (US)

(21) Appl. No.: 18/062,323

(22) Filed: Dec. 6, 2022

(51) Int. Cl. H04L 67/568; H04M 15/00; H04W 4/24

(52) U.S. Cl. CPC H04L 67/568; H04M 15/8228; H04W 4/24

(57) ABSTRACT

A charging function (CHF) of a carrier network may perform charging operations despite stale cache data. For example, the CHF may request that a first subscriber database server (SDS) perform operations associated with a charging request associated with a subscriber based on a mapping of the subscriber to the first SDS in the cache of the CHF. The CHF may receive a response indicating the first SDS failed to perform the operations associated with the charging request and request a mapping of the subscriber to a SDS of a plurality of SDSs from a server mapping subscribers of the carrier network to respective SDSs of the plurality of SDSs. The CHF may receive a mapping of the subscriber to a second SDS of the plurality of SDSs and request that the second SDS perform the operations associated with the charging request.

### BACKGROUND

Modern cellular communication networks delivering calling and multimedia services often include a charging system. A charging function (CHF) of the charging system may store charging data records (CDRs) or other subscriber data during charging operations using a subscriber database spread across multiple subscriber database servers (SDSs). To handle a high number of transactions, the CHF may maintain a mapping of subscribers to respective SDSs in cache. While using cache may be advantageous, stale cache data in the CHF may cause problems.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating a communication system that may perform charging operations despite the presence of stale cache data.

FIG. 2 is a flow diagram illustrating an example method for performing charging operations despite the presence of stale cache data in the example system of FIG. 1.

FIG. 3 is a flow diagram illustrating an example method for performing charging operations despite the presence of stale cache data in the example system of FIG. 1.

FIG. 4 is a block diagram illustrating relevant high-level components of a device that may be used to implement various of the components described herein.

### DETAILED DESCRIPTION

The described implementations provide devices, systems, and methods that perform charging operations despite the presence of stale cache data.

In some examples, performing charging operations despite the presence of stale cache data may comprise receiving, at the SMF, a message in a communication session established between the UE and a network. An initial charging process may be performed when the communication session is established. During the initial charging process, one or more data units may be granted to the UE to receive content and/or service from the providers.

Messages received during the communication session may include information related to the communication session and the usage of the one or more granted data units. The SMF may further determine, from the message, usage of the plurality of data units and determine that an event occurs during the communication session. When the event triggers a charging condition, the SMF may generate a charging request to the CHF based on the usages of the plurality of data units and the event. In some examples, the handling of charging requests described herein may apply at least to the create, update and terminate requests over the Gy or N40 and Sy or N28 interfaces between the SMF and CHF.

The CHF may maintain information about the granted data units in a subscriber database spread across multiple subscriber database servers (SDSs). For example, the CHF may store charging data records (CDRs) or other subscriber data for a particular subscriber to a particular SDS that is mapped to the particular subscribers (e.g., based on an association of a SDS ID to the subscriber).

In some examples, upon receiving a charging request, the CHF may determine if a mapping of the subscriber associated with the charging request to an SDS ID is stored in cache. If not, the CHF may perform a lookup to a DNS or similar mapping server storing the mapping to determine a SDS of the multiple SDSs mapped to the subscriber of the UE. In addition, the CHF may store the SDS ID of the SDS mapped to the subscriber of the UE to the cache. The CHF may then utilize the SDS ID retrieved from cache or the DNS server in performing operations associated with the charging request.

As mentioned above, stale cache data in the CHF may cause problems. For example, when a subscriber is deleted and provisioned again on a different SDS (e.g., when the SDS mapped to the subscriber changes to a different SDS), the cache in the CHF may hold the old SDS ID for the subscriber. As such, a charging request to the CHF may be directed to the wrong SDS and may therefore result in a failure. In prior systems, upon receiving such a failure, the carrier typically may choose to: (1) allow free usage, thereby losing revenue; or (2) bar the subscriber, thereby creating a bad customer experience. This issue may continue until the stale cache data is cleared, for example, by a system reset or a DNS time-to-live of the stale cache data expiring.

In certain described embodiments, when the SDS associated with the cached SDS ID returns a “subscriber not found” error or similar error in response to a request from the CHF, the CHF may be configured to perform a re-lookup to get the latest SDS ID for the subscriber from the DNS server. Once the CHF has obtained the latest SDS ID for the subscriber, the CHF may update the cache and forward the request to the new SDS.

In some implementations, the techniques discussed herein may be implemented in the context of protocols associated with one or more of 3G, 4G, 4G LTE, and/or 5G protocols. In some examples, the network implementations may support standalone architectures, non-standalone architectures, dual connectivity, carrier aggregation, etc. Example implementations are provided below with reference to the following figures.

While charging platforms and the operations thereof are utilized in the discussions of example embodiments throughout this disclosure, this disclosure and the appended claims are not so limited. For example, while the discussion herein of highlights embodiments of a CHF operating despite stale cache data, the operations herein may be utilized by other network functions which maintain a cache mapping subscribers to database servers storing portions of a database.

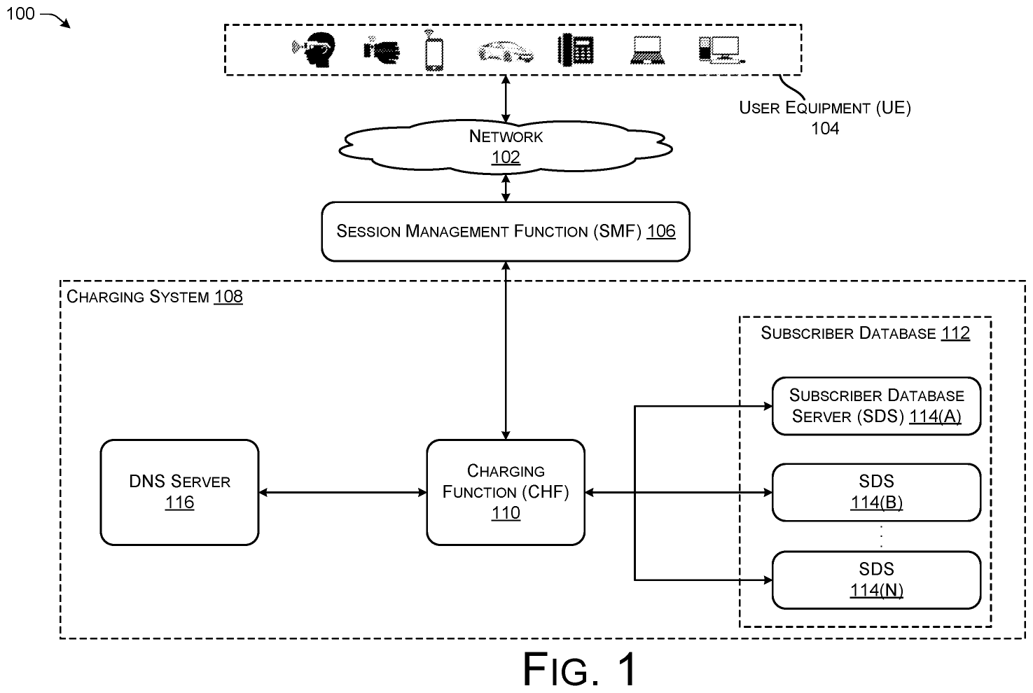

FIG. 1 illustrates an example telecommunication system 100, which may perform charging operations despite the presence of stale cache data. The system 100 includes a network 102 of a carrier, user equipment (UE) 104, a session management function (SMF) 106 and a charging system 108. The charging system 108 may include a charging function (CHF) 110, a subscriber database 112 stored across a plurality of SDS servers 114(A)-114(N), and a DNS server 116.

The network 102 may be compatible with one or more radio access technologies, wireless access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMAX technology, Wi-Fi technology, and/or any other previous or future generation of radio access technology.

The UE 104 may be any device that can connect to the network 102 through one or more access points (not shown) of the network 102. In some examples, the UE 104 may be a mobile device, such as a cellular phone or a smart phone. In other examples, the UE 104 may be a traditional landline phone. In other examples, the UE 104 may be an IP phone. In yet other examples, the UE 104 may be a personal digital assistant (PDA), a media player, a tablet computer, a gaming device, a personal computer (PC) such as a laptop, desktop, or workstation, or any other type of computing or communication device. In some examples, the UE 104 may include the computing devices implemented on the vehicle such as an autonomous vehicle or a self-driving vehicle. In some examples, the UE 104 may be a wearable device such as a smart watch, smart glasses, etc.

The access points may include one or more base stations that communicate with the UE 104 and the network 102. In some examples, the base station may be associated with an LTE access network known as an Evolved UMTS Terrestrial Radio Access Network (E-UTRAN). Base stations of the LTE access network can be known as eNBs. In some implementations, the base station may be associated with a 5G access network with base stations known as gNBs or as new radio (NR) base stations. The base station may connect to the network 102 via various interfaces for transmission of user data and/or control data. The UE 104 may access the services provided by the network 102 through different access points based on the types of the UE 104 and the type of the services.

In some implementations, the SMF 106 may act as a charging transfer function (CTF). The CTF may generate charging events toward the CHF 110 of the charging system 108, which may be responsible for generating Charging Data Records (CDRs). The charging system 108 may perform the charging and/or billing functions directed to subscriber accounts associated with the subscribers of the network services.

In an example, a subscriber may send a request for service delivery via the UE 104 to the network 102. The request for service delivery may initiate a session to be established for the UE 104.

Upon receiving the request for service delivery, the SMF 106 may establish a session for the UE 104 to receive the service. The session may be a protocol data unit (PDU) session. In response to the request for service delivery, the SMF 106 may send a charging request directed to the associated subscriber account to the CHF 110. For example, the SMF 106 may communicate with the CHF 110 in the charging system 108 to determine whether the subscriber account has sufficient balance for the requested service.

The CHF 110 may maintain information about the granted data units in the subscriber database 112 spread across the subscriber database servers (SDSs) 114(A)-114N. For example, the CHF 110 may store charging data records (CDRs) or other subscriber data to an SDS 114(A) of the multiple SDSs 114 based on a mapping of subscribers to respective SDSs 114.

In an example, upon receiving a charging request from the SMF 106, the CHF 110 may determine if a mapping of the subscriber associated with the charging request to an SDS ID is stored in cache (not shown) of the CHF 110. If not, the CHF 110 may perform a lookup to the DNS server 116 or similar server storing the mappings to retrieve a SDS ID of a SDS 114 of the multiple SDSs 114 mapped to the subscriber of the UE 104. In addition, the CHF 110 may store a mapping of the the retrieved SDS ID of the SDS 114 to the subscriber of the UE to the cache of the CHF 110. The CHF 110 may then utilize the SDS ID retrieved from cache or the DNS server 116 in performing operations associated with the charging request. One of ordinary skill in the art would understand the handling of charging requests after obtaining the current SDS ID in view of this disclosure.

As mentioned above, examples according to this disclosure, the CHF 110 may be configured to overcome problems that may be caused by stale cache data in the CHF.

When the associated SDS (e.g., 114(A)) of the subscriber changes to a different SDS (e.g., 114(B)), the cache in the CHF 110 may continue to hold the mapping of the subscriber to the old SDS ID (e.g., of SDS 114(A)). As such, the CHF 110 may attempt to utilize the wrong SDS 114 in processing the charging request. As a result, the old SDS 114 may return a failure response (e.g., a “subscriber not found” message).

When the SDS 114 associated with the cached SDS ID returns a “subscriber not found” error or similar error in response to a charging request, the CHF 110 may be configured to perform a DNS or similar re-lookup to get the latest SDS ID for the subscriber from the DNS server 116. Once the CHF 110 has obtained the latest SDS ID for the subscriber, the CHF 110 may update the cached mapping to associate the subscriber and the new SDS ID and then utilize the new SDS ID to perform operations associated with the charging request with the new SDS.

The SMF 106 and components of the charging system 108, i.e., the CHF 110, the subscriber database 112, the SDSs 114, and the DNS server 116 may be implemented on one or more computing devices and/or data centers. The one or more computing devices may include but not limited to a single computing system or an edge host providing physical or virtual computing resources as known by persons skilled in the art. Other well-known computing devices, systems, environments and/or configurations that may be suitable for use with the examples described herein include, but are not limited to, personal computers, server computers, hand-held or laptop devices, multiprocessor systems, microprocessor-based systems, network PCs, mainframe computers, distributed computing environments, etc. The data centers may be a cloud storage that are associated with a plurality of physical storages located at one or more locations. The plurality of physical storages may span a plurality of servers, which sometimes are located in multiple locations. The physical storages are typically owned and managed by a hosting company. A cloud storage provider of the data center is responsible for securing the data stored therein and keeping the data accessible via the network. The cloud storage services may be accessible through a cloud computing service, a web service application programming interface (API) or by applications that utilize the API, such as cloud desktop storage, a cloud storage gateway, or a Web-based content management system.

It should be appreciated that the telecommunication system 100 in a 5G network is merely for illustrative purposes. The present disclosure is not intended to be limiting. For example, the charging system 108 may include other network functions (NFs) to act as the charging function. The charging system 108 may be deployed in 5G equivalent wireless network or later generation wireless network. The use of the terms described above is also meant to include any different named 5G equivalents or later generation equivalents.

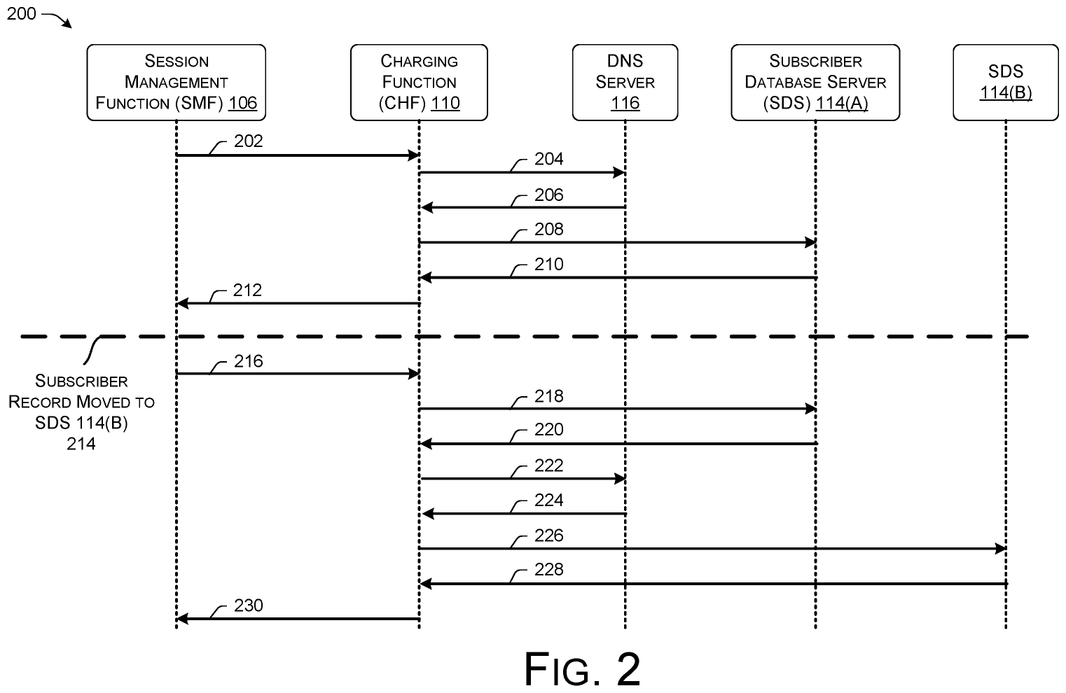

FIG. 2 illustrates an example method 200 for performing charging operations despite the presence of stale cache data in the example system of FIG. 1, according to some implementations. In the illustrated example, the data flow relates to the flow of requests and responses between the SMF 106, the CHF 110, the SDSs 114 and the DNS server 116. More particularly, the illustrated example of FIG. 2 includes the SMF 106 initiating a charging session for a subscriber UE with the CHF 110 during which the subscriber's associated SDS is changed from SDS 114(A) to SDS 114(B).

At 202, the SMF 106 may send a charging request to the CHF 110. More particularly, the SMF 106 may send a subscribe/create charging request to the CHF 110 to establish a charging session for a subscriber associated with a UE 104.

At 204, upon receiving the subscribe/create charging request from the SMF 106, the CHF 110 may determine if a mapping of the subscriber associated with the charging request to an SDS ID is stored in the cache of the CHF 110. In the illustrated example, the CHF 110 may determine that the cache does not include a mapping for the subscriber. In response, the CHF 110 may send a DNS request to the DNS server 116 for the SDS ID associated with the subscriber.

At 206, the DNS server 116 may receive the DNS request from the CHF 110. In response to the DNS request, the DNS server 116 may determine the SDS ID of the SDS 114(A) is associated with the subscriber. The DNS server 116 may send a DNS response to the CHF 110 that may include the SDS ID of the SDS 114(A) associated with the subscriber. Upon receiving the DNS response, the CHF 110 may store the SDS ID of the SDS 114(A) in association with the subscriber of the UE to the cache of the CHF 110.

At 208, the CHF 110 may utilize the SDS ID of SDS 114(A) in performing operations associated with the subscribe/create charging request received from the SMF 106. For example, the CHF 110 may generate a charging data record (CDR) for the charging session associated with the subscriber and send a SDS request to the SDS 114(A) to store the CDR for the charging session.

In response, at 210, the SDS 114(A) may store the CDR for the charging session in the subscriber database 112 and send a SDS response to the CHF 110 indicating success. At 212, the CHF 110 may send the SMF 106 a response to the subscribe/create charging request indicating success (e.g., a 201—OK message).

At 214, the subscriber record for the subscriber may be moved from the SDS 114(A) to the SDS 114(B). The subscriber record may be moved between SDSs 114 for various reasons. For example, the SDSs 114 may handle subscriber data on a regional basis, subscribers may be assigned to SDSs 114 using a load balancing mechanism, and so on. In particular example, the subscriber may move from a first region associated with the SDS 114(A) to a second region associated with the SDS 114(B). The subscriber database 112 may be updated by moving the record of the subscriber to the SDS 114(B) and the mapping in the DNS server 116 may be updated. In another example, the subscriber may be deleted (e.g., due to termination of service) and a new subscriber may be assigned the subscriber ID. A load balancing mechanism may choose SDS 114(B) to handle the new subscriber's data upon creation of the new account for the new subscriber and the mapping in the DNS server 116 may be updated.

At 216, the SMF 106 may send another charging request to the CHF 110. More particularly, the SMF 106 may send a subscribe/create charging request, an update charging request, a terminate/delete charging request or so on to the CHF 110. In the illustrated example, the SMF 106 may send an update charging request to the CHF 110 to update the data usage associated with the charging session created in response to the charging request at 202.

At 218, the CHF 110 may determine if a mapping of the subscriber associated with the update charging request to an SDS ID is stored in the cache of the CHF 110. In the illustrated example, the cache of the CHF 110 may continue to store stale cache data mapping the subscriber to the SDS 114(A). CHF 110 may then utilize the stale SDS ID of the SDS 114(A) retrieved from cache in performing operations associated with the update charging request. More particularly, the CHF 110 may send a message to the SDS 114(A) to update the CDR for the subscriber based on the updated usage in the update charging request received at 216.

At 220, the SDS 114(A) may determine the SDS 114(A) does not store data for the subscriber and return a response indicating a failure or “subscriber not found” to the CHF 110.

At 222, based on the response indicating failure or “subscriber not found” from the SDS 114(A), the CHF 110 may send a new DNS request to the DNS server 116 for the SDS ID associated with the subscriber.

At 224, the DNS server 116 may receive the new DNS request from the CHF 110. The DNS server 116 may then determine the SDS ID of the SDS 114(B) is associated with the subscriber. The DNS server 116 may send another DNS response to the CHF 110 that may include the SDS ID of the SDS 114(B) associated with the subscriber. Upon receiving the DNS response, the CHF 110 may replace the stale mapping in the cache with the mapping of the SDS ID of the SDS 114(B) to the subscriber of the UE.

At 226, the CHF 110 may utilize the SDS ID of SDS 114(B) in performing operations associated with the update charging request received from the SMF 106. For example, the CHF 110 may generate an updated charging data record (CDR) for the charging session based on the usage data included in the update charging request from the SMF 106 and send a SDS request to the SDS 114(B) to store the updated CDR for the charging session.

In response, at 228, the SDS 114(B) may store the updated CDR for the charging session in the subscriber database 112 and send a SDS response to the CHF 110 indicating success. At 230, the CHF 110 may send the SMF 106 a response to the update charging request indicating success (e.g., a 201—OK message).

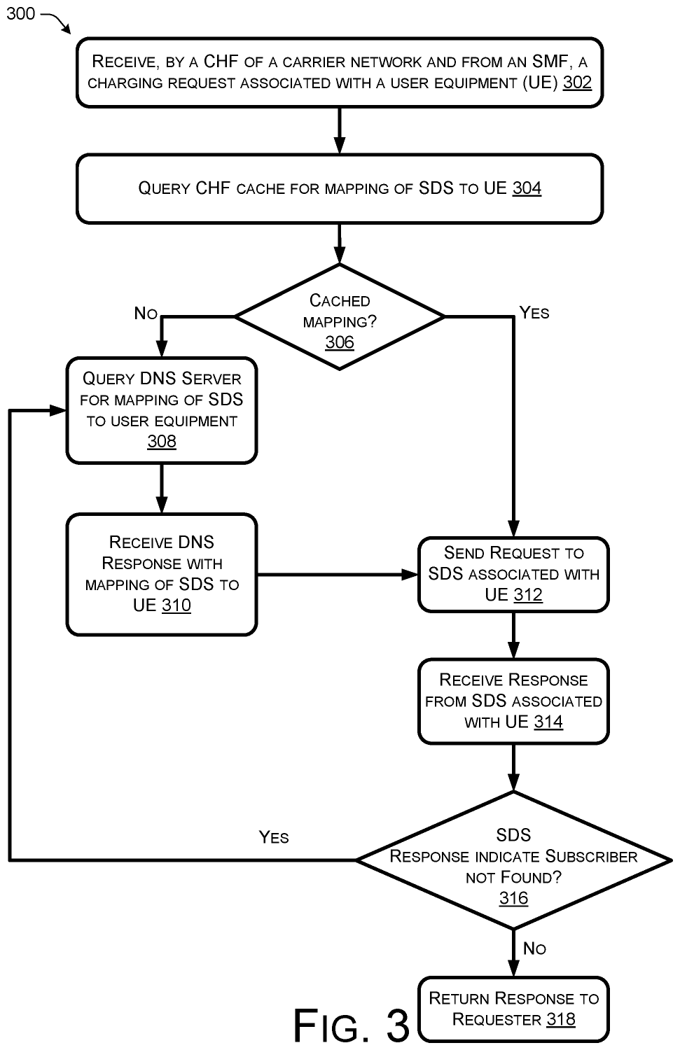

FIG. 3 illustrates an example method 300 for performing charging operations despite the presence of stale cache data, according to some implementations.

At 302, the CHF of a carrier network may receive, from an SMF, a charging request associated with user equipment of a subscriber. At 304, the CHF may query a cache of the CHF for a mapping of a SDS to the UE of the subscriber.

At 306, the CHF may determine whether the cache of the CHF included a mapping of a SDS to the UE of the subscriber. If not, the process may continue to 308. If so, the process continues to 312.

At 308, the CHF may query a DNS server for a mapping of a SDS to the UE of the subscriber. At 310, the CHF may receive a DNS response with a mapping of a SDS to the UE.

At 312, the CHF may send, to the SDS associated with the UE, a SDS request based on the request received from the SMF. At 314, the CHF may receive a response from the SDS associated with UE.

At 316, the CHF may determine whether the response from the SDS indicates the “subscriber was not found” or a similar failure. If so, at 314, the process may return to 308. Otherwise, the process continues to 318.

At 318, the CHF may return a response to the requester (e.g., SMF) indicating the charging request was performed successfully.

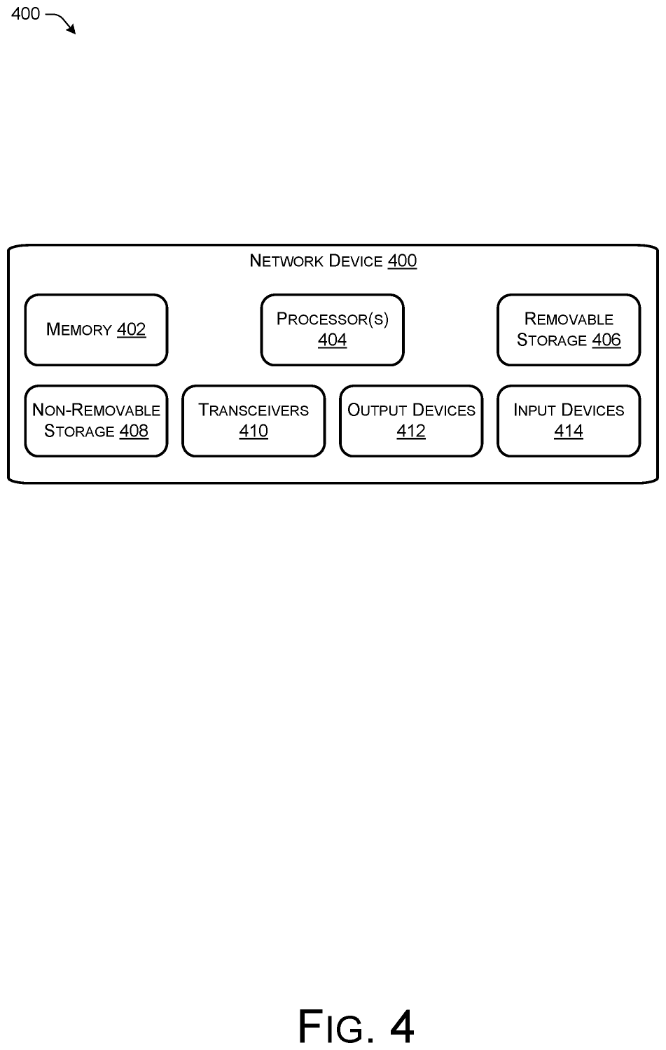

FIG. 4 illustrates a component level view of a telecommunication network device 400 capable of implementing the CHF 110 and other network devices of FIG. 1. The network device 400 may, as an example, comprise a physical or virtual computer server. The network device 400 may comprise a system memory 402 storing various executable components and data for implementing the systems and methods 100-300 of FIGS. 1-3. The network device 400 may further comprise processor(s) 404, a removable storage 406, a non-removable storage 408, transceivers 410, output device(s) 412, and input device(s) 414, any or all of which can be communicatively connected via a communications bus (not shown).

In various examples, the system memory 402 is volatile (such as RAM), non-volatile (such as ROM, flash memory, etc.) or some combination of the two. In some examples, the processor(s) 404 is a central processing unit (CPU), a graphics processing unit (GPU), or both CPU and GPU, or any other sort of processing unit.

The network device 400 also includes additional data storage devices (removable and/or non-removable) such as, for example, magnetic disks, optical disks, or tape. Such additional storage is illustrated in FIG. 4 by removable storage 406 and non-removable storage 408. The system memory 402, removable storage 406 and non-removable storage 408 are all examples of non-transitory computer-readable storage media.

In some examples, the transceivers 410 include any sort of transceivers known in the art. For example, transceivers 410 may include a radio transceiver that performs the function of transmitting and receiving radio frequency communications. Also, or instead, the transceivers 410 may include other wireless or wired connectors, such as Ethernet connectors or near-field antennas. The transceivers 410 may facilitate connectivity between a public network, such as a packet-switched access network (not shown), and one or more other devices of a telecommunication network.

In some examples, the output devices 412 include any sort of output devices known in the art, such as a display, speakers, a vibrating mechanism, or a tactile feedback mechanism. Output devices 412 also include ports for one or more peripheral devices, such as headphones, peripheral speakers, or a peripheral display.

In various examples, the input devices 414 include any sort of input devices known in the art. For example, the input devices 414 may include a camera, a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
requesting, by a charging function (CHF) of a carrier network, that a first subscriber database server (SDS) perform operations associated with a charging request, wherein:
the charging request is associated with a subscriber in a subscriber database maintained by a plurality of SDSs including the first SDS; and
the first SDS is mapped to the subscriber in a cache of the CHF;
receiving, by the CHF and from the first SDS, a response indicating the first SDS failed to perform the operations associated with the charging request;
requesting, by the CHF and based on the response from the first SDS, a mapping of the subscriber to a SDS of the plurality of SDSs from a mapping server mapping subscribers of the carrier network to respective SDSs of the plurality of SDSs;
receiving, by the CHF and from the mapping server, the mapping of the subscriber to a second SDS of the plurality of SDSs; and
requesting, by the CHF, that the second SDS perform the operations associated with the charging request.

2. The method of claim 1, wherein the charging request is one of an update charging request associated with a charging session associated with the subscriber or a terminate charging request associated with the charging session.

3. The method of claim 1, wherein the response from the first SDS indicating the first SDS failed to perform the operations associated with the charging request indicates that the subscriber was not found in a portion of the subscriber database maintained by the first SDS.

4. The method of claim 1, wherein the mapping server is a domain name system (DNS) server.

5. The method of claim 1, further comprising, prior to requesting the first SDS perform the operations associated with the charging request:
receiving, by the CHF, the charging request from a session management function (SMF); and
retrieving a cached mapping of the subscriber to the first SDS of the plurality of SDSs from the cache of the CHF, wherein the requesting the first SDS perform the operations associated with the charging request is based at least in part on the cached mapping.

6. The method of claim 1, further comprising:
receiving, by the CHF, a response from the second SDS indicating the second SDS successfully performed the operations associated with the charging request; and
sending, to an SMF associated with the charging request, a charging response indicating the charging request was performed.

7. The method of claim 1, wherein the mapping of the subscriber to the second SDS of the plurality of SDSs includes an identifier of the second SDS.

8. The method of claim 1, wherein the charging request is associated with usage by the subscriber of 5G services of the carrier network.

9. A system comprising:
one or more computing devices of a first carrier configured to perform actions comprising:
requesting, by a charging function (CHF) of a carrier network, that a first subscriber database server (SDS) perform operations associated with a charging request, wherein:
the charging request is associated with a subscriber in a subscriber database maintained by a plurality of SDSs including the first SDS; and
the first SDS is mapped to the subscriber in a cache of the CHF;
receiving, by the CHF and from the first SDS, a response indicating the first SDS failed to perform the operations associated with the charging request;
requesting, by the CHF and based on the response from the first SDS, a mapping of the subscriber to a SDS of the plurality of SDSs from a mapping server mapping subscribers of the carrier network to respective SDSs of the plurality of SDSs;
receiving, by the CHF and from the mapping server, the mapping of the subscriber to a second SDS of the plurality of SDSs; and
requesting, by the CHF, that the second SDS perform the operations associated with the charging request.

10. The system of claim 9, wherein the charging request is one of a update charging request associated with a charging session associated with the subscriber or a terminate charging request associated with the charging session.

11. The system of claim 9, wherein the response from the first SDS indicating the first SDS failed to perform the operations associated with the charging request indicates that the subscriber was not found in a portion of the subscriber database maintained by the first SDS.

12. The system of claim 9, wherein the actions further comprise, prior to requesting the first SDS perform the operations associated with the charging request:
receiving, by the CHF, the charging request from a session management function (SMF); and
retrieving a cached mapping of the subscriber to the first SDS of the plurality of SDSs from the cache of the CHF, wherein the requesting the first SDS perform the operations associated with the charging request is based at least in part on the cached mapping.

13. The system of claim 9, wherein the actions further comprise:
receiving, by the CHF, a response from the second SDS indicating the second SDS successfully performed the operations associated with the charging request; and
sending, to an SMF associated with the charging request, a charging response indicating the charging request was performed.

14. The system of claim 9, wherein the charging request is associated with usage by the subscriber of 5G services of the carrier network.

15. A non-transitory computer-readable media storing computer-executable instructions, which when executed by one or more processors, cause the one or more processors to perform actions comprising:
requesting, by a charging function (CHF) of a carrier network, that a first subscriber database server (SDS) perform operations associated with a charging request, wherein:
the charging request is associated with a subscriber in a subscriber database maintained by a plurality of SDSs including the first SDS; and
the first SDS is mapped to the subscriber in a cache of the CHF;
receiving, by the CHF and from the first SDS, a response indicating the first SDS failed to perform the operations associated with the charging request;
requesting, by the CHF and based on the response from the first SDS, a mapping of the subscriber to a SDS of the plurality of SDSs from a mapping server mapping subscribers of the carrier network to respective SDSs of the plurality of SDSs;
receiving, by the CHF and from the mapping server, the mapping of the subscriber to a second SDS of the plurality of SDSs; and
requesting, by the CHF, that the second SDS perform the operations associated with the charging request.

16. The non-transitory computer-readable media of claim 15, wherein the charging request is one of a update charging request associated with a charging session associated with the subscriber or a terminate charging request associated with the charging session.

17. The non-transitory computer-readable media of claim 15, wherein the response from the first SDS indicating the first SDS failed to perform the operations associated with the charging request indicates that the subscriber was not found in a portion of the subscriber database maintained by the first SDS.

18. The non-transitory computer-readable media of claim 15, wherein the actions further comprise, prior to requesting the first SDS perform the operations associated with the charging request:
receiving, by the CHF, the charging request from a session management function (SMF); and
retrieving a cached mapping of the subscriber to the first SDS of the plurality of SDSs from the cache of the CHF, wherein the requesting the first SDS perform the operations associated with the charging request is based at least in part on the cached mapping.

19. The non-transitory computer-readable media of claim 15, wherein the actions further comprise:
receiving, by the CHF, a response from the second SDS indicating the second SDS successfully performed the operations associated with the charging request; and
sending, to an SMF associated with the charging request, a charging response indicating the charging request was performed.

20. The non-transitory computer-readable media of claim 15, wherein the charging request is associated with usage by the subscriber of 5G services of the carrier network.
